(19) United States
(12) Patent Application Publication
(10) Pub. No.: US 2016/0297362 A1
(43) Pub. Date: Oct. 13, 2016

(54) VEHICLE EXTERIOR SIDE-CAMERA SYSTEMS AND METHODS

(71) Applicant: Ford Global Technologies, LLC, Dearborn, MI (US)

(72) Inventors: Louis TIJERINA, Dearborn, MI (US); John SHUTKO, Ann Arbor, MI (US)

(21) Appl. No.: 14/682,977

(22) Filed: Apr. 9, 2015

(51) Int. Cl. B60R 1/00; H04N 5/232; G06F 3/01; H04N 7/18; G06K 9/00

(52) U.S. Cl. CPC B60R 1/00; H04N 7/181; G06K 9/00832; G06F 3/013; H04N 5/23216; H04N 5/23238; B60R 2300/60; B60R 2300/802

(57) ABSTRACT

A vehicle exterior viewing system is described. The displayed images represent the external environment around a vehicle. The displayed images are controlled by detecting at least one of the eye gaze and the head position of the driver. An exterior viewing imager system can produce the image data and can include a camera and a gimbal to support the camera. At least one display is adapted to display an exterior image from the imager system. A tracker system senses position and/or gaze of the driver. A controller receives data from the tracker and the imager system to change an image on the display based on data from the tracker. In an example, the imager system includes a driver-side imager positioned on a driver-side of the vehicle to provide a diver-side view of the vehicle and a passenger-side imager positioned on a passenger-side of the vehicle to provide a passenger-side view of the vehicle.

### TECHNICAL FIELD

The present disclosure is directed to an exterior facing camera that provides views for a driver to see the exterior environment of the vehicle.

### BACKGROUND

Vehicles include mirrors that allow a driver to partially see the side and rear of the vehicle. The mirrors can be adjustable so that each individual driver can see beside or behind the vehicle. However, many drivers adjust the side view mirrors so that they can see their own vehicle and beside the vehicle to provide a visible egocentric reference frame to understand the view in the mirror. This may result in blind spots at the side of the vehicle and also behind the vehicle.

### SUMMARY

A vehicle exterior viewing system is described. The displayed images represent the external environment around a vehicle. The displayed images are controlled by detecting at least one of the eye gaze, the head position, driver location and driver orientation. An exterior viewing imager system can produce the image data and can include a camera and a gimbal to support the camera. At least one display is adapted to display an exterior image from the imager system. A tracker system senses position and/or gaze of the driver. A controller receives data from the tracker and the imager system to change an image on the display based on data from the tracker. In an example, the imager system includes a driver-side imager positioned on a driver-side of the vehicle to provide a diver-side view of the vehicle and a passenger-side imager positioned on a side of the vehicle to provide a passenger-side view of the vehicle.

In an example, a vehicle exterior viewing system includes an exterior viewing imager system including a camera and a gimbal to support the camera, a display adapted to display an exterior image from the imager system, a tracker to sense position of the driver, and a controller to change an image on the display based on data from the tracker. An imager system can include both a driver side imager and a passenger side imager.

In an example, the controller shifts the image on the display based on the tracker determining that the driver is viewing the display and is shifting to view a different location exterior the vehicle.

In an example, the controller sends signals to control actuators connected to the gimbal to move the camera based on the tracked position of the driver.

In an example, the imager system includes a rear-view imager to provide a rear view image behind the vehicle.

In an example, the controller combines the driver-side image and the rear view image for showing on the display.

In an example, the display includes a plurality of screens with a first screen adapted to show the drive-side view and a second screen to show a passenger-side view.

In an example, the plurality of screens includes a center, third screen, and wherein the controller is to show views on the first and third screens that overlap to reduce likelihood of a blind spot on the driver side of the vehicle and to show views on the second and third screens that overlap to reduce likelihood of a blind spot on the passenger side of the vehicle.

In an example, the controller uses data relating to a seat position to adjust field of view of the camera.

In an example, the tracker tracks eye gaze of the driver in a driver seat to adjust the field of view of the camera.

In an example, the gimbal includes actuators to adjust yaw and pitch of the camera in response to signals from the controller based on the tracker detected position of the eye gaze of the driver.

In an example, the controller can receive an image that is processed to show the pertinent part of the environment around the vehicle. The controller can also receive a plurality of images and combine them to create a display image that shows a pertinent part of the environment around the vehicle.

### BRIEF DESCRIPTION OF THE DRAWINGS

FIG. 1 is a view of a vehicle with an imaging system to view environment outside the vehicle.

FIG. 2 is a schematic view of the imaging system for a vehicle.

FIG. 3 is a view of an imager for a vehicle.

FIG. 4 is a view of an imager for a vehicle.

FIG. 5 is a view of a vehicle interior.

FIG. 6 is a view of a gaze tracking system.

FIG. 7 is a schematic view of the image system for a vehicle.

### DETAILED DESCRIPTION

As required, detailed embodiments of the present invention are disclosed herein; however, it is to be understood that the disclosed embodiments are merely exemplary of embodiments of the invention, which can include various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Vehicle display systems and methods for operating the same are described that provides improved viewing of the exterior environment around that vehicle. An imager is mounted to the vehicle and takes exterior images that can be displayed to the driver. Exterior images can be views of the environment outside the vehicle. The imager can include a camera and a gimbal supporting the camera such that the camera can move in multiple axis to provide a more complete view outside the vehicle than traditional side view mirrors as typically adjusted by drivers can provide. The gimbal can also operate to keep the imager level to better view the environment outside the vehicle.

The vehicle display system can include a driver head tracker with a sensor for monitoring the driver's head position or the driver's eye position, a display for displaying images from outside the vehicle the vehicle driver, and a controller for controlling at least one of the display to modify displayed information depending on the driver position and the image position from the imager. The driver tracking system can be automated such that the driver need not adjust while driving.

The imager can change its position by actuators connected to the gimbal, which will thus change the camera image viewpoint, to enable the display to show a different viewing angle to the driver. In an example, the display viewpoint image can be modified when a side movement of the head or the eyes in the transversal direction of the vehicle is detected by the tracker. Additionally, the zoom distance of the display image can be modified when the tracker detects a movement of the head or eyes in the longitudinal direction of the vehicle.

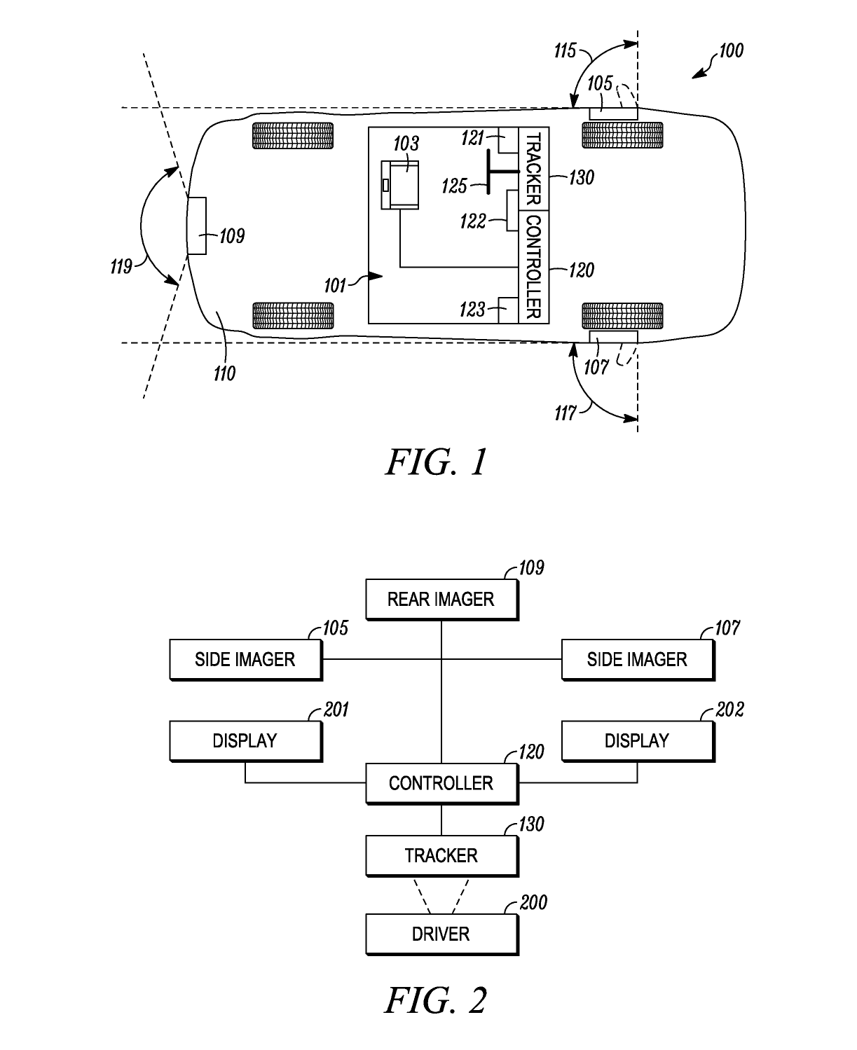

FIG. 1 shows a schematic view of a vehicle 100, such as an automobile, a truck or the like. The vehicle 100 includes a cabin 101 with a seat 103 whereat a driver can sit to operate the vehicle. During operation of the vehicle and move specifically when driving the vehicle the driver needs to see the environment exterior to the vehicle for safe operation. Vehicle 100 may include side view mirrors on both the driver and passenger sides of the vehicle to allow the driver to see beside the vehicle. The vehicle 100 may include a rear view mirror to allow the driver to see behind the vehicle. However, mirrors may have drawbacks if the driver does not position the mirrors to see the entirety of the environment exterior the vehicle. It is known that drivers may not always adjust the mirrors to eliminate blind spots that cannot be seen in mirrors around the vehicle. Additionally, side mirrors exterior the vehicle 100 create drag and reduce mileage during vehicle operation.

Vehicle 100 includes an imaging system that may include at least one driver side imager 105, at least one passenger side imager 107 and, optionally, a rear view imager 109. The imagers 105, 107 and 109 can be mounted in the body 110 of the vehicle 100 to have a low profile and reduce drag. The imagers 105, 107 and 109 can include a camera and a gimbal (the camera and gimbal are described in greater detail with reference to FIG. 4) to support the camera and allow the camera to be adjustable so that the camera can move to provide a complete field of view from its location, either driver side, passenger side or rear of the vehicle. In an example, the cameras are wide angle cameras that can essentially image their view about the vehicle. More specifically, the driver side imager 105 can produce an image of at least the field of view 115, which can be 120 degrees or less, about 90 degrees or greater than 75 degrees. Similarly, the passenger side imager 107 can produce an image of at least the field of view 117, which can be 120 degrees or less, about 90 degrees or greater than 75 degrees. The rear imager 109 can produce an image of a field of view 119 that is greater than 90 degrees, greater than 120 degrees and up to about 170 degrees. It will be noted that the fields of view 115, 117 (side exterior images) can overlap the rear field of view 119. The images from imagers 105, 107 and 109 can be sent to an image controller for display inside the cabin 101. The positioning of the camera can be made by actuators that direct the camera on the gimbal.

The vehicle 100 further includes a controller 120 that can receive images from the imagers 105, 107 and 109 and provide images or process images for viewing in the cabin on at least one display. The cabin 101 in the embodiment shown in FIG. 1 includes a plurality of displays 121, 122 and 123. The controller 120 can send an image of the driver side to the driver side display 105, an image of the rear of the vehicle to center display 122, and an image of the passenger side to the passenger side display 123. The images on the driver side display 121 and the center display 122 can overlap and at least partially show the same image. The images on the passenger side display 123 and the center display 122 can overlap and at least partially show the same image. In an embodiment, there is only a single display, e.g., center display 122, which shows at least two of the three views, e.g., driver and passenger sides around the vehicle. Such a display could be bifurcated with the driver side part of the display showing the driver side view and the passenger side part of the same display showing the passenger side view.

Unlike traditional mirrors, providing the controller 120 to process the images from the imagers 105, 107 and 109, allows the displayed images to be more than the static images produced by the imagers 105, 107 and 109. For example, the controller 120 could zoom in on part of the image created by any of the imagers 105, 107 and 109. When parking a vehicle, the driver may wish to have an enlarged view to show greater detail and enhance the distance between the vehicle and objects or obstacles around the vehicle, e.g., posts, meters, other vehicles, curbs, snow banks and the like. The driver can indicate to the controller 120 the desired view, e.g., by manipulating input devices mounted in the cabin 101, e.g., on the dashboard or on the steering wheel 125. The input devices can be track pads, knobs, switches, joy sticks or other pointing devices. For example, the controller 120 may zoom in the image based on the position of the driver. The vehicle sensors may sense the driver moving toward the display in response to which the controller will zoom in on the displayed image. The vehicle sensors may sense the driver moving away from the display in response to which the controller will zoom out of the displayed image.

The controller 120 can, in an embodiment, automate the processing the views displayed in the vehicle on displays 121-123. The controller 120 can include circuitry, a computer and/or a processor that can carry out mathematical and logic calculations. Examples of processors can include a Central Processing Unit (CPU), Digital Signal Processor (DSP), Graphics Processor Unit (GPU), Driver Boards for other devices, power supply control elements, diagnostic routines, which may execute computer algorithms and machine code for calculations. The controller may further include memory devices such a random access memory, persistent memory, media borne memory device, programmable memory devices and other information storage technologies.

A tracking system 130 can be in the vehicle that tracks the position of the driver, who is seated in the seat 103. The tracking system 130 can include one or more inward-facing cameras and/or other types of detectors to supply data to the controller about the location of the driver, e.g., head position (fore and aft as well as side to side), head pose (e.g., head yaw angle or pitch angle), and where the driver's eyes are looking. The tracking system 130 may have circuitry that executes instructions, e.g., a computer program, to analyze the location of the driver's eyes, reflections of the eyes and/or where the eyes are looking. The vision-tracking system 130 can monitor physical characteristics as well as other features associated with the driver's eye or eyes. Based upon these monitored features, a set of gaze attributes can be constructed in the tracking system 130 and provided to the controller 120 to control the views on the displays 121-123. Examples of gaze attributes can include an angle of rotation or a direction of eye gaze (e.g., with respect to the head), a diameter of the pupil of eye, a focus distance, a current volume or field of view and so forth. In an example, tracking system 130 can tailor gaze attributes to a particular user's eye or eyes. In a further example, machine learning can be employed to adjust or adapt to personal characteristics such as iris color (e.g., relative to pupil), a shape of eye 108 or associated features, known or determined deficiencies, or the like. This can be useful when there are different drivers that use the vehicle or the driver deviates from a standard default driver as programmed into the tracking system 130. The tracking system 130 can also track the position of the driver's body, e.g., the head. When the driver turns the head and gazes toward one display, the tracker will indicate such a movement. By way of example, the driver may turn their head and look at driver side display 121. If the driver makes a head movement, then the view shown on display 121 may change. If the driver moves his/her head up, the view may shift downward. If the driver moves their head down the view on display 121 may move up. These actions mimic traditional mirrors. The tracking system 130 may also determine that the driver moves toward the display. This may trigger the view on the display to zoom in. If the tracking system determines that the driver moves away from the display 121, the display may zoom out. The tracking system may also detect if the driver squints while viewing a display, e.g., display 121 or 123. This may trigger the display on the viewed display 121 or 123 to zoom in.

The tracker system 130 may provide sensed driver tracking data to the controller 120. The controller 120, in turn, uses this data to control the image on the display(s) 121-123. In an example, the controller 120 receives information of the position of the seat 103.

FIG. 2 shows a schematic block diagram of a system for providing external views around a vehicle. A plurality of imagers 105, 107, 109 can produce images external to the vehicle. In an example, the imagers 105, 107 and 109 can produce a visual representation around the vehicle, e.g., both driver sides with or without a rear view. In an example, the imagers 105 and 107 can produce data representing the exterior environment on both sides of the vehicle. A controller 120 receives the image data from the imagers 105, 107 and 109. The controller 120 can show images of the external environment on the displays 201, 202. In an example, the displays 201 and 202 are separately positioned in the vehicle, e.g., on the driver and passenger sides of the cabin. These different displays can be on the dashboard or positioned on the A pillars of the vehicle. Other locations that can be readily seen by the driver can also be used as locations for the displays 201, 202. In an example, the displays 201, 201 are different regions on a single display, e.g., a heads-up display or a single screen, which can be part of the instrument cluster. A tracking system 130 tracks the driver 200 to determine the driver's gaze, i.e., where the driver is looking. The tracking system 130 provides the driver's gaze information to the controller 120. The controller 120 can then change the images on the displays 201, 202 based at least in part on the driver's gaze information. The controller 120 can zoom in the images on the display being viewed by the driver or can change the displayed image, e.g., up, down, left or right depending on the driver's gaze.

The controller 120 can operate to provide an output image to the displays 201, 202 based on the tracked driver data and the image data from the imagers 105, 107 and 109. The controller 120 can show the same image on each display or separate, unique images on each display. The controller 120 can also show images that overlap, at least in part, with other images shown on other displays. For example, the driver side display 121 can have part of its displayed image being the same as part of the image displayed on the center display 122 and/or the passenger display 123. The center display 122 can have part of its displayed image being the same as part of the image displayed on the driver side display 121 and/or the passenger display 123. The controller 120 can also move the image on any of the displays 121-123 with the image being shown being less than the total image taken by the imagers 105, 107, and 109. The controller can change the image on any of the displays 122-123 in opposite of the tracked movement of the driver. The image on the displays 121-123 can move down when the driver is tracked up and can move up when the driver is tracked down. The image movement can also work the same way for tracked driver movement to the left and to the right. The image on the displays 121-123 can move right when the driver is tracked left and can move left when the driver is tracked right. The controller 120 is also capable of computing a diagonal movement of the image when a diagonal movement of the driver's position is detected. In another example, the tracker can determine which display 121-123 that the driver is looking at and only move the image on that display based on the tracked driver gaze and movement. In an example, the controller 120 can also change the displayed image in the same direction as the driver is tracked. That is, when the driver is tracked to the left, then the controller moves to the displayed image to the left; when the driver is tracked to the right, then the controller moves to the displayed image to the right.

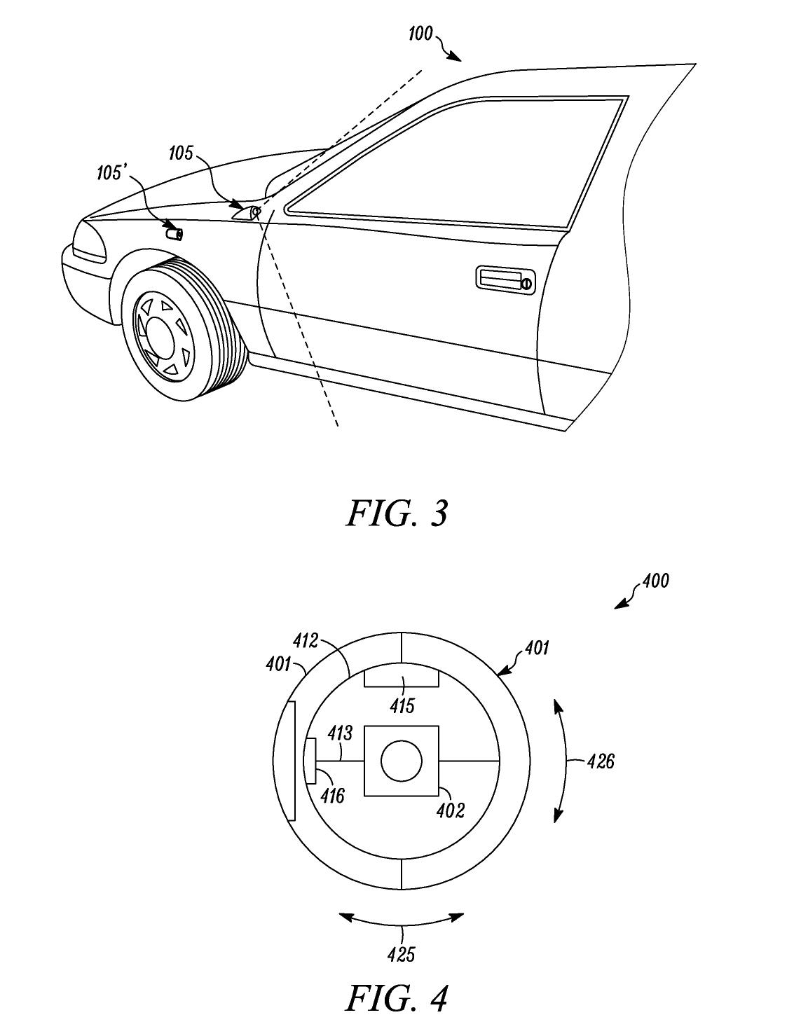

FIG. 3 shows the driver side imager 105 positioned on the vehicle 100 at the front quarter panel in front of the A pillar defining a corner of the cabin. The imager 105 can be at the lower start of the A pillar, e.g., on top of the vehicle body. An alternate position of the imager 105′ is shown on the side of the front quarter panel above the wheel. The imagers 105, 105′ can image the environment on this shown side of the vehicle.

FIG. 4 shows an imager 400 that can be used as any of the imagers 105, 107, and/or 109. Imager 400 includes a camera 402 in a support 401. The camera 402 can include a digital imaging device, e.g., a charge coupled device or a CMOS device. The support 401 can include a gimbal that allows the camera 402 to move in at least two directions. In an example, the gimbal allows the camera to move in three directions, e.g., in X, Y and Z direction, or in two directions, e.g., X and Y directions. The support 401 can include a fixed outer brace 411 in which an intermediate brace 412 is pivotally connected. Thus, the intermediate brace 412 can pivot relative to the outer brace 411. In the example shown in FIG. 4, the intermediate brace 412 can pivot in the direction 425. An inner brace 413 is pivotally connected to the intermediate brace 412. In the example shown in FIG. 4, the inner brace 413 can pivot in the direction 426. The imager 400 can also include actuators 415, 416 that can operate to control the position of the camera 402. The actuators 415, 416 can pivot the intermediate brace 412 (in direction 425) or the inner brace 413 (in direction 426), respectively, to direct camera at a location external to the vehicle that the driver wants to see. In an example, the controller 120 sends signals to the actuators 415, 416 to move the camera 402. The controller 120 can use the driver's gaze information to send the control signals to the actuators 415, 416.

In an alternative embodiment, the camera 402 can be supported by a fixed support 401. The camera 402 can have a sufficiently wide angle lens, e.g., a fish eye lens, wide angle lens or ultra wide angle lens, so that it can take a wide viewing angle image. Such a wide angle image will contain the field of view that may be desired by the driver to inform the driver of the environment around the vehicle. The camera 402 can provide this wide angle image. A wide angle image can have a field of view of greater than 90 degrees, greater than 120 degrees or greater than 145 degrees in various embodiments. If the field of view is provided by the lens on the camera 402, then wide-angle lens refers to a lens whose focal length is substantially smaller than the focal length of a normal lens for a given film plane.

The controller can receive the image data from the camera 402 and process the image data so that a pertinent part of the image is shown on a display to the driver. For example, the controller can crop the image and show only a small part of the vehicle. A larger part of the image displayed by the controller will be environment around the vehicle. In another example, the controller receives image data from a plurality of cameras 402 and combines the image data for display.

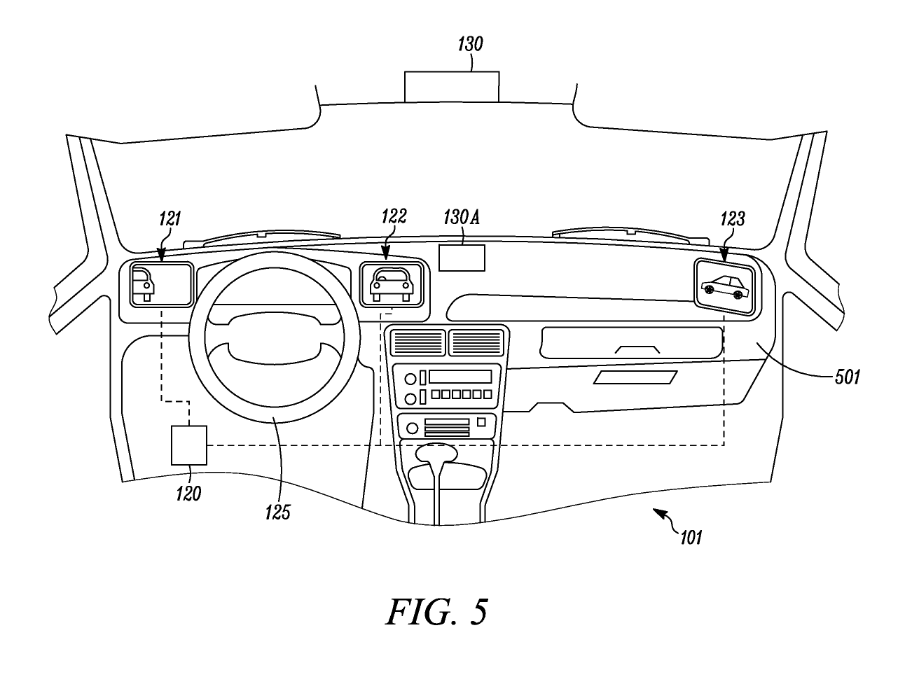

FIG. 5 shows a partial view of a vehicle cabin 101 with the plurality of displays 121-123 with each showing an exterior view around the vehicle on the driver side, rear, and passenger side of the vehicle, respectively. Displays 121-123 are positioned on the dashboard 501. The controller 120 processes the image data from the imagers (not shown in FIG. 5) in view of data provided by the tracker 130 (and/or tracker 130′) to control the views on the displays 121-123. The displays 121-123 are positioned to be readily viewable by a driver seated in alignment with the steering wheel 125. The views in the displays can overlap with parts of the rear view including partial views from each of the side imagers.

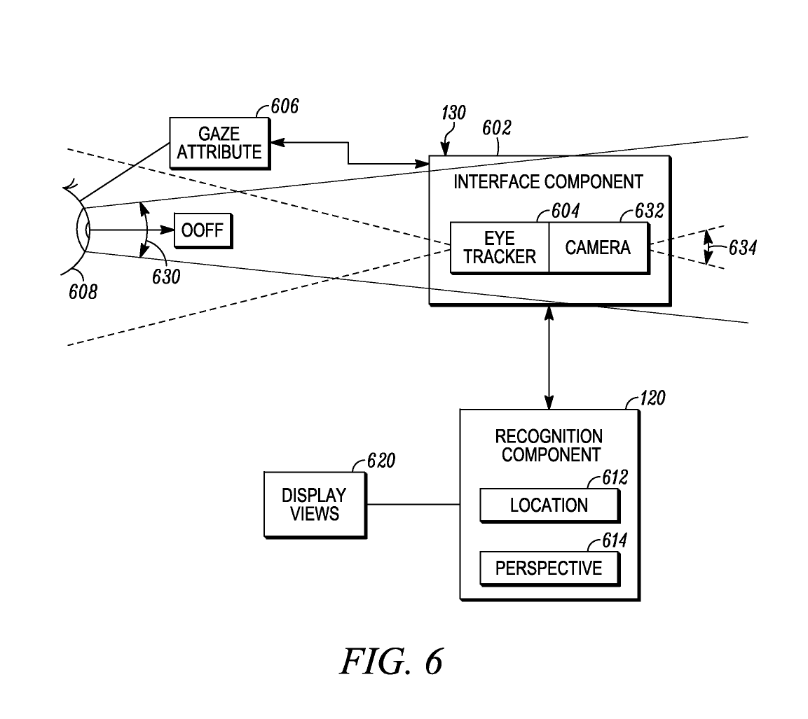

FIG. 6 shows tracking system 130 and controller 120. The tracking system 130 and controller 120 operate to utilize vision-tracking techniques to provide a driver with exterior views around the vehicle. Tracking system 130 can include interface component 602, which can be operatively coupled to or include vision-tracking component 604. Vision-tracking component 604 can monitor physical characteristics as well as other features associated with an eye or eyes 108 associated with a driver. Based upon these monitored features, a set of gaze attributes 606 can be constructed. By way of illustration, gaze attributes 606 can include an angle of rotation or a direction of eye 608 (e.g., with respect to the head), a diameter of the pupil of eye 606, a focus distance, a current volume or field of view (e.g., view 630) and so forth. The vision-tracking component 604 can tailor gaze attributes to a particular user's eye or eyes 608. In an example, machine learning can be employed to adjust or adapt to personal characteristics such as iris color (e.g., relative to pupil), a shape of eye 608 or associated features, known or determined deficiencies, or the like. The interface component 602 can further sense the position and direction of the driver's head. The controller 120 can also include a recognition component 610 that can obtain gaze attributes 606, indication of location 612, indication of perspective (or direction) 614, and employ these obtained data to determine or identify a view 620 of an exterior of the vehicle to be shown on at least one of the displays 121-123. The view 620 can include at least part of the exterior environment captured by at least one of the imagers 105, 107 or 109.

The location indication 612 can be a location of the direction of the driver's head, e.g., a determination of which of the displays 121-123 at which the driver's gaze is directed. This indication 612 may be based on a two-dimensional (2D) or a three-dimensional (3D) coordinate system, such as latitude and longitude coordinates (2D) as well as a third axis of elevation. The perspective indication 614 may relate to a 3D orientation of the driver. Both indications 612, 614 can be obtained from sensors included in or operatively coupled to either interface component 602 or recognition component 610. Indications 612, 614 may also be provided by sensed position of the driver's face or head. In another example, indications 612, 614 may also include data provided device or structure associated with the user.

The recognition component 610 can determine the location 612 of the driver's gaze to a corresponding point or location related to the exterior of the vehicle. The perspective indication 614 can also be translated to indicate a base perspective or facing direction desired for viewing by the driver. Gaze attributes 606 can be added to thus determine a real, physical, current field of view 630 desired by the driver. The view(s) shown on the displays 121-123 can be updated in real time as any or all of the user's location 112, perspective 114, or gaze attributes 106 changes.

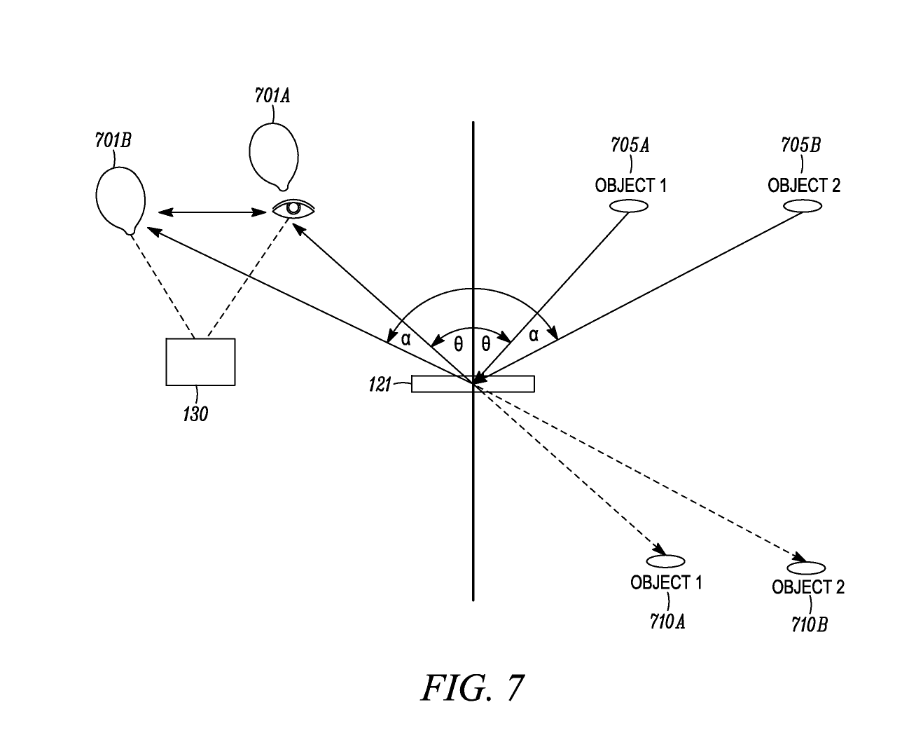

FIG. 7 shows a schematic view of a display 121 and the tracker 130 interacting with a driver 701. The tracker 130 determines the view of the driver, e.g., as the driver is looking at the display 121. The driver 701A is the initial default position. Object 1 at 705A is imaged by the imager (not shown) and shown on display 121 at position 710A. The driver may move his or her head a distance d to position 701B. The tracker 130 detects this movement. Object 2 at 705B is now in the position to be viewed by the driver. The movement vector data representing distance and direction d from the tracker 130 controls the image shown on display 121 to change from object 1 705A to object 2 705B. Object 2 image 710B, previously unseen, will be shown on display 121 in the position shown, i.e., at the correct optical distance. Thus, the driver can control the image on the display by changing the position of their head. Alternatively, the tracker can track the eye gaze and control image shown on the display based on the tracked eye gaze.

According to another embodiment of the invention, the head tracking system includes means for monitoring driver gaze direction. An even more refined interactive system can be achieved by monitoring eye movement. Thus, detection of gaze direction can be used for modification of displayed information, for example can certain information on a display be highlighted when an eye movement away from the display is detected. Alternatively or additionally, an eye movement to a certain field of the display may confirm that a message displayed in said field has been viewed by the driver. The display may also be adapted for displaying information related to vehicle status.

Embodiments described herein use vision-tracking techniques to control the displays of the external environment of a vehicle to a driver. The systems described can include displays that show images that can be controlled by a vision-tracking component.

Vehicles may include automobiles, trucks, tractors, heavy duty vehicles commercial vehicles, water vehicles, boats, motorcycles, motor vehicles and the like. The presently described systems and methods can be used for any conveyance in which a person requires views of the outside environment to safely operate the vehicle.

The present disclosure describes providing images of the sides and rear of the vehicle. However, the present disclosure is also adaptable to show the front of the vehicle. While a driver should be looking at the front of the vehicle during operation, it may be helpful in some situations, e.g., parking, to show a view of the front of the vehicle to avoid obstacles and hazards as well as the rear and sides around the vehicle. The present disclosure is not limited to a specific view of the environment around the vehicle. The systems, components and methods may be adapted to show the environment behind, laterally, in front or combinations thereof around the vehicle with the entire view on a single display or having the view divided into parts that are respectively shown on displays. The partial views can include some overlapping parts so that the driver can quickly orient the views relative to each other and to the vehicle. In an example, the displays can mimic the side mirrors and rear view mirror. However, in some examples, the images on the displays overlap and have some unique content in the displayed images.

Embodiments of the present disclosure can operate similar to traditional mirrors that drivers typically to have a portion of the vehicle's side body panel visible in the mirror imagery. Drivers may like such a view to have a visible egocentric reference frame. This is one reason why people do not eliminate the blind spot though mirror positioning from the outset. The present tracking and display embodiments can track head position and eye gaze to adjust the displays shown to the driver dynamically. Some presently described embodiments allow the adjustment of the driver's viewing angle independent of the blind spot through body, head and eye adjustments. The imagers can adjust the camera to show the desired view of the external environment. In another example, the controller processes the image data from the imager to show the desired view of the external environment. The default view could be a view that includes a portion of the vehicle in the displayed image(s).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle exterior viewing system comprising:
an exterior viewing imager system including a camera and a gimbal to support and orient the camera;
a display adapted to display an exterior image from the imager system;
a tracker to sense position of a driver; and
a controller to change an image on the display based on data from the tracker.

2. The system of claim 1, wherein the imager system includes a driver-side imager positioned on a driver-side of the vehicle to provide a diver-side view of the vehicle and a passenger-side imager positioned on a passenger-side of the vehicle to provide a passenger-side view of the vehicle.

3. The system of claim 2, wherein the controller shifts the image on the display based on the tracker determining that the driver is viewing the display and is shifting to view a different location exterior the vehicle.

4. The system of claim 3, wherein the controller sends signals to control actuators connected to the gimbal to move the camera based on the position of the driver.

5. The system of claim 2, wherein the imager system includes a rear-view imager to provide a rear view image behind the vehicle.

6. The system of claim 5, wherein the controller combines the driver-side image and the rear view image for showing on the display.

7. The system of claim 2, wherein the display includes a plurality of screens with a first screen adapted to show the driver-side view and a second screen to show a passenger side view.

8. The system of claim 7, wherein the plurality of screens includes a center, third screen, and wherein the controller is to show views on the first and third screens that overlap to reduce likelihood of a blind spot on the driver side of the vehicle and to show views on the second and third screens that overlap to reduce likelihood of a blind spot on the passenger side of the vehicle.

9. The system of claim 8, wherein the controller receives image data from a plurality of imagers of the exterior viewing imager system and combines image data from at least two of the plurality of imagers to produce a composite view on at least one of the first screen, the second screen, the third screen or combinations thereof.

10. The system of claim 2, wherein the controller uses data relating to a seat position to adjust field of view of the camera.

11. The system of claim 10, wherein the tracker tracks eye gaze of the driver in a driver seat to adjust the field of view of the camera.

12. The system of claim 11, wherein the gimbal includes actuators to adjust yaw and pitch of the camera in response to signals from the controller based on the eye gaze of the driver.

13. A vehicle exterior viewing system comprising:
an exterior viewing imager system including a driver side imager, a passenger side imager and a rear imager;
a controller configured to receive image data from the driver side imager, the passenger side imager and the rear imager and to combine the image data from at least two of the driver side imager, the passenger side imager and the rear imager to produce an output image; and
a display adapted to display the output image from the controller.

14. The system of claim 13, wherein the display includes a center display that is configured to show a panoramic view of the exterior of the vehicle including a drive side, a rear side and a passenger side.

15. The system of claim 14, wherein the controller includes a tracking system to track movement of the driver and is configured to control the output image based on tracking data from the tracking system.

16. The system of claim 15, wherein the controller changes the image on the display in opposite of tracked movement of the driver with the image on the display moving down when the driver is tracked up and moving up when the driver is tracked down.

17. The system of claim 15, wherein the controller changes the image on the display in opposite of tracked movement of the driver with the image on the display moving left when the driver is tracked right and moving right when the driver is tracked left.

18. The system of claim 15, wherein the controller is configured to send the output image to a plurality of displays including a driver side display, a center display and a passenger side display.

19. The system of claim 18, wherein each of the driver side display, the center display and the passenger side display have a unique part of the output image.

20. The system of claim 15, wherein a first part of the output image is displayed on both the driver side display and the center display and a second part of the output image is displayed on both the passenger side display and the center display.

21. A vehicle exterior viewing system comprising:
an exterior viewing imager system including a driver side imager and a passenger side imager;
a controller configured to receive image data from the driver side imager and the passenger side imager and to combine the image data from the driver side imager and the passenger side imager to produce an output image; and
a display adapted to display the output image from the controller.
